(19) United States
(12) Patent Application Publication
(10) Pub. No.: US 2018/0089578 A1
(43) Pub. Date: Mar. 29, 2018

(54) SYSTEMS AND METHODS FOR TRANSITIONING USER ACCOUNTS

(71) Applicant: Facebook, Inc., Menlo Park, CA (US)

(72) Inventors: Ashish Kumar Yadav, Mountain View, CA (US); Daniel Dinu, Sunnyvale, CA (US)

(21) Appl. No.: 15/276,587

(22) Filed: Sep. 26, 2016

(51) Int. Cl. G06N 99/00; H04L 29/08

(52) U.S. Cl. CPC G06N 99/005; H04L 67/306

(57) ABSTRACT

Systems, methods, and non-transitory computer-readable media can train a machine learning model to classify at least one user account as either a first type of account or a second type of account based at least in part on one or more respective features corresponding to the user account and determine that a first user account that was created as the first type of account should be converted to the second type of account based at least in part on the machine learning model.

### FIELD OF THE INVENTION

The present technology relates to the field of account transition. More particularly, the present technology relates to techniques for identifying user accounts to be transitioned from one type of account to another type.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

### SUMMARY

Various embodiments of the present disclosure can include systems, methods, and non-transitory computer readable media configured to train a machine learning model to classify at least one user account as either a first type of account or a second type of account based at least in part on one or more respective features corresponding to the user account and determine that a first user account that was created as the first type of account should be converted to the second type of account based at least in part on the machine learning model.

In an embodiment, the first type of account corresponds to a social profile in a social networking system, and wherein the second type of account corresponds to a social page in the social networking system.

In an embodiment, the systems, methods, and non-transitory computer readable media are configured to provide at least one notification instructing a user associated with the first user account to convert the first user account to the second type of account.

In an embodiment, the systems, methods, and non-transitory computer readable media are configured to generate a set of training examples that each include a set of features that describe social profiles of a plurality of users.

In an embodiment, the set of features include a count of the user's social connections that are also social connections of one another in a social networking system.

In an embodiment, the set of features include a count of tokens determined from information associated with the user that match one or more predefined tokens, the predefined tokens referencing terms that are associated with the second type of account.

In an embodiment, the set of features include information indicating a relationship status of the user as specified in a social networking system.

In an embodiment, the set of features include a count of the user's social connections that are family members in a social networking system.

In an embodiment, the set of features include a count of birthday greetings sent by the user to social connections through a social networking system.

In an embodiment, the set of features include a count of message threads that are active between the user and one or more other users of a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example account transition module, according to an embodiment of the present disclosure.

FIG. 2 illustrates an example feature extraction module, according to an embodiment of the present disclosure.

FIG. 3 illustrates an example model training module, according to an embodiment of the present disclosure.

FIG. 4 illustrates an example evaluation module, according to an embodiment of the present disclosure.

FIGS. 5A-B illustrate an example social profile and an example social page, according to various embodiments of the present disclosure.

FIG. 6 illustrates an example process for evaluating user accounts, according to various embodiments of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Transitioning User Accounts

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, a user can sign-up for an account to create a social profile that is published through a social networking system. The social profile can include various information about the user as well as any posts and content items that were submitted by the user. Similarly, an administrator of an organization, or entity, can sign-up to create a social page that is also published through the social networking system. The social page can include various information about the organization as well as any posts and content items that were submitted by the administrator. In general, social profiles are intended for individuals and non-commercial use while social pages are intended for organizations (or entities) for commercial use. A social profile can differ from a social page in a number of ways. For example, an administrator of a social page is able to access various tools that help the administrator to develop their business and brand. In one example, the administrator can create advertisements to promote their business through the social networking system. In another example, the administrator can access information that describes how users of the social networking system have interacted with the social page. In another example, users can engage with a social page by simply fanning, or following, the social page by selecting an option to do so. In contrast, a social profile is a medium for an individual to share posts with other users (or social connections) in the social networking system. Further, when engaging with social profiles, a first user must send a friend request to a second user (and the second user must accept that request) before the first user can engage with a social profile of the second user.

In some instances, an administrator of an organization may inadvertently sign-up to create a social profile instead of a social page. Under conventional approaches, such errors in the sign-up process are identified manually. A manual approach is not scalable, however, given the potentially large number of accounts in the social networking system that may have been incorrectly created as social profiles rather than social pages. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, a model can be trained to analyze accounts that were created as social profiles to determine which of those accounts should be converted from social profiles to social pages. The model can be trained to make this determination based in part on various features extracted from the social profiles and/or social pages. Once trained, the model can be provided a set of features describing a social profile as input and the model can determine whether the social profile should be converted to a social page. In some embodiments, a notification is sent to the user of the account to inform the user about options for transitioning the social profile to a social page.

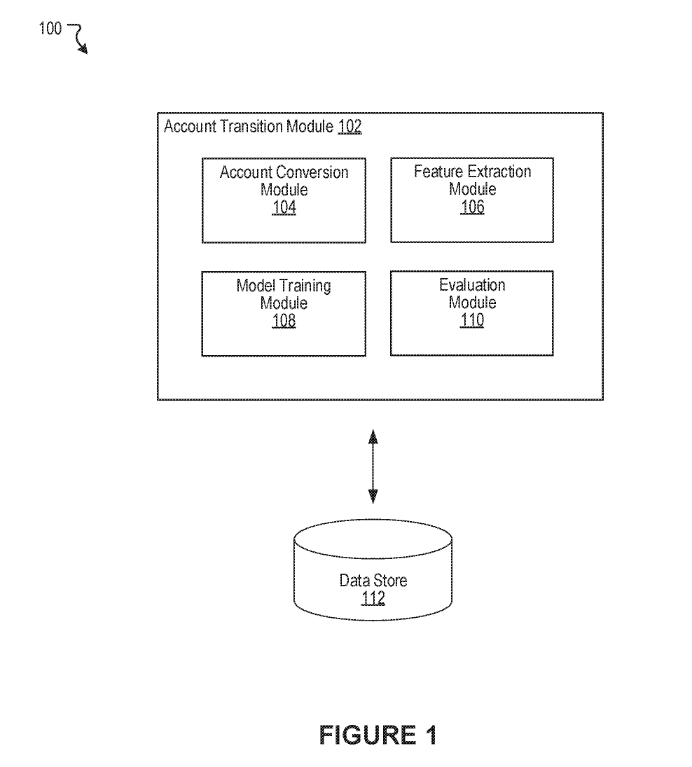

FIG. 1 illustrates an example system 100 including an example account transition module 102, according to an embodiment of the present disclosure. As shown in the example of FIG. 1, the account transition module 102 can include an account conversion module 104, a feature extraction module 106, a model training module 108, and an evaluation module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

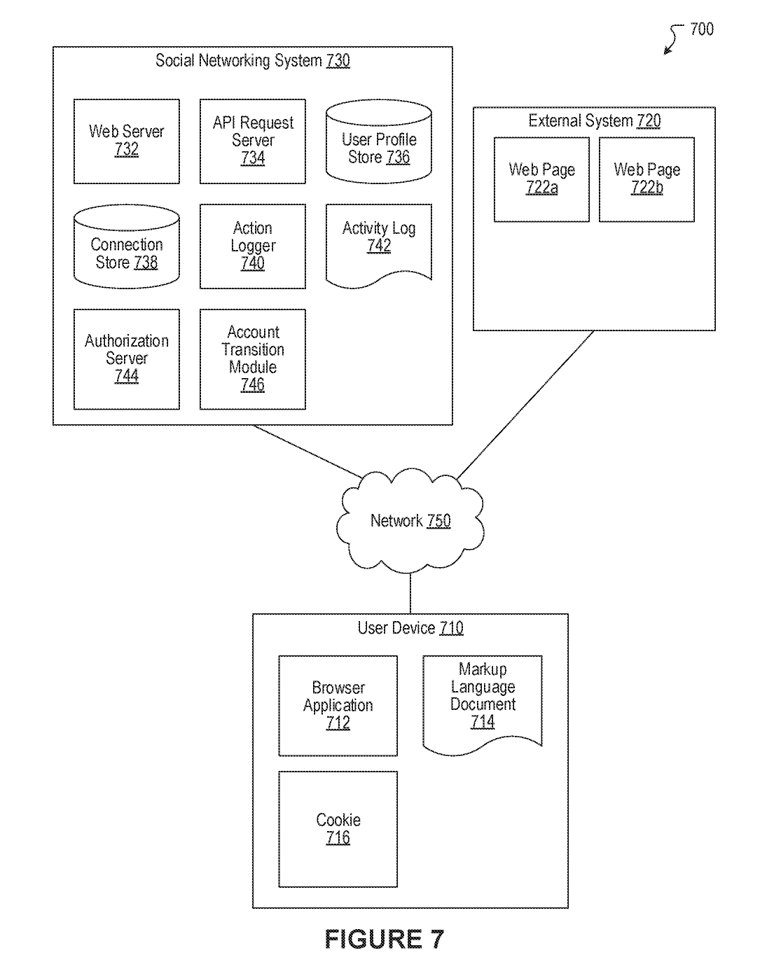

In some embodiments, the account transition module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the account transition module 102 can be implemented, in part or in whole, as software running on one or more computing devices or systems, such as on a user or client computing device. In one example, the account transition module 102 or at least a portion thereof can be implemented as or within an application (e.g., app), a program, or an applet, etc., running on a user computing device or a client computing system, such as the user device 710 of FIG. 7. In another example, the account transition module 102 or at least a portion thereof can be implemented using one or more computing devices or systems that include one or more servers, such as network servers or cloud servers. In some instances, the account transition module 102 can, in part or in whole, be implemented within or configured to operate in conjunction with a social networking system (or service), such as the social networking system 730 of FIG. 7.

The account transition module 102 can be configured to communicate and/or operate with the at least one data store 112, as shown in the example system 100. The at least one data store 112 can be configured to store and maintain various types of data. For example, the data store 112 can store information describing user social profiles that were created through the social networking system as well as data related to the social profiles (e.g., user posts, comments, groups, images, etc.). The data store 112 can also store information describing social pages created through the social networking system as well as data related to the social pages (e.g., posts, comments, images, etc.). In some implementations, the at least one data store 112 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data.

As mentioned, the account transition module 102 can, in part or in whole, be implemented within or configured to operate in conjunction with a social networking system (or service), such as the social networking system 730 of FIG. 7. In various embodiments, the account transition module 102 can be configured to identify user accounts that are eligible to be transitioned from social profiles to social pages. Although the approaches described herein specifically reference “social profiles” and “social pages”, these approaches can be adapted to identify any type of account to be transitioned to any other type of account based on some set of features corresponding to the accounts.

In some embodiments, the account conversion module 104 is configured to provide users with an option to automatically convert their social profile to a social page. For example, a user that inadvertently created a social profile account can voluntarily select the option to have the social profile be converted to a social page. In this example, the account conversion module 104 can automatically import various information associated with the social profile and use the information to create a corresponding social page. For example, the account conversion module 104 can import any content (e.g., biography description, posts, images, etc.) that was published in the social profile and incorporate that content into the newly created social page.

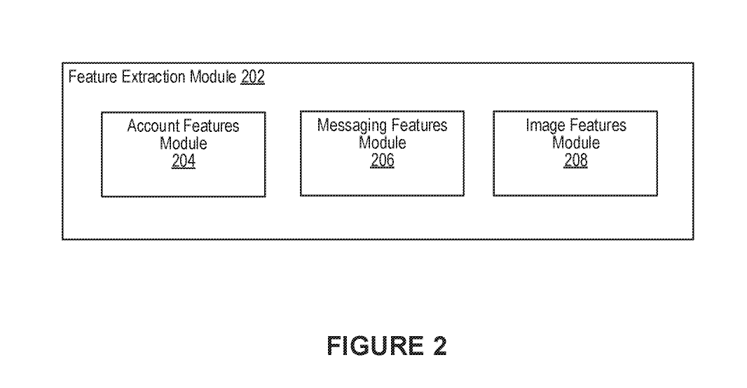

In various embodiments, the feature extraction module 106 is configured to determine sets of features from existing social profiles and/or social pages. These features can be used to generate training examples for training a model to determine whether a user account should be modified to use a social page rather than a social profile. More details regarding the feature extraction module 106 will be provided below with reference to FIG. 2.

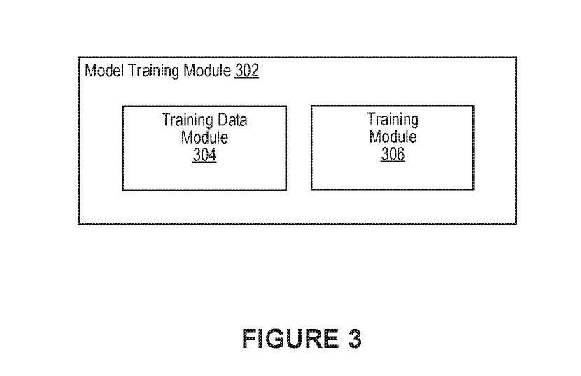

In various embodiments, the model training module 108 is configured to train and utilize a model to determine whether a user account should be modified to use a social page rather than a social profile. The user account can be migrated from using a social profile to a social page based on the model's output. More details regarding the model training module 108 will be provided below with reference to FIG. 3.

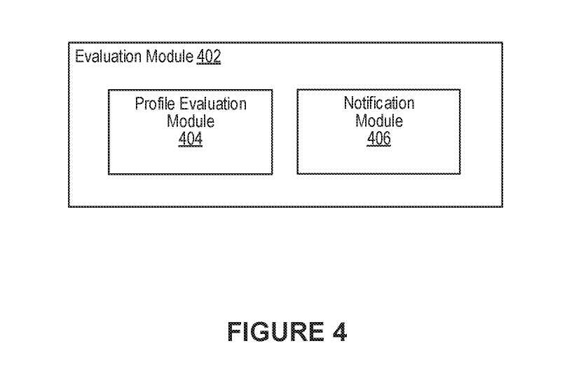

Once the model is trained, the evaluation module 110 can be used to determine whether a user account should be transitioned from a social profile to a social page. More details regarding the evaluation module 110 will be provided below with reference to FIG. 4.

FIG. 2 illustrates an example of a feature extraction module 202, according to an embodiment of the present disclosure. In some embodiments, the feature extraction module 106 of FIG. 1 can be implemented as the feature extraction module 202. As shown in FIG. 2, the feature extraction module 202 can include an account features module 204, a messaging features module 206, and an image features module 208.

In various embodiments, the feature extraction module 202 is configured to determine one or more features from social profiles and/or social pages associated with user accounts in the social networking system. These features can be included in training examples that will be used to train a machine learning model, as described below. For example, a set of features can be determined from a user account associated with a social profile using one or more of the approaches described below. Some, or all, of these features can be included in a training example along with a label specifying a classification of the social profile (e.g., the social profile is a positive example or the social profile is a negative example).

In various embodiments, the account features module 204 is configured to determine one or more features from information describing a user account. For example, in some embodiments, the account features module 204 can determine a count of the user's social connections (or friends) that are also social connections of one another. This count can be used as a feature for training the model. In general, a first user of the social networking system can send a friend request to a second user. Once the second user accepts the friend request, the first user and the second user are recognized by the social networking system as social connections. Typically, an individual (or non-commercial) user of the social networking system will have a group of social connections and some of these social connections will also be social connections of one another. In contrast, social connections of a business user are typically unlikely to be social connections of one another in the social networking system since they are generally customers. Thus, the count of the user's social connections that are also social connections of one another provides one measure of distinguishing between a proper social profile and a social profile that should be a social page.

In some embodiments, the account features module 204 is configured to determine one or more features based on whether information associated with the user's social profile includes one or more page tokens and/or profile tokens. In general, page tokens (e.g., uni-grams, bi-grams, or any n-gram) reference terms that are typically associated with social pages. The term “Warehouse” is an example of a page token since this term is generally used in business names. In contrast, profile tokens (e.g., uni-grams, bi-grams, or any n-gram) reference terms that are generally associated with social profiles. The term “Smith” is an example of a profile token since this term is generally associated with an individual's name. In such embodiments, the account features module 204 can tokenize the user's name (or user name) into n-grams (e.g., uni-grams, bi-grams, etc.). The account features module 204 can then determine a count of matches between the token corresponding to the user's name (or user name) and page tokens (and/or profile tokens). In some embodiments, the number of tokens in the user's name (or user name) that match page tokens can be used as a feature for training the model. In some embodiments, the number of tokens in the user's name (or user name) that match profile tokens can be used as a feature for training the model.

In some instances, the user may specify an employer name (or company name) to be shown in the user's social profile. In some embodiments, one or more features are determined based on the number of tokens in the employer name that match page tokens (and/or profile tokens. For example, in some embodiments, the number of tokens in the employer name that match page tokens can be used as a feature for training the model. In some embodiments, the number of tokens in the employer name that match profile tokens can be used as a feature for training the model.

In some embodiments, the account features module 204 is configured to determine one or more features based on a Uniform Resource Locator (URL) (e.g., http://www.example.com/user.name5131) associated with the user's social profile. This URL may be used to access the social profile over a network, for example. In such embodiments, the account features module 204 can tokenize the portion of this URL that references the user's social profile (e.g., “user.name5131”) into n-grams. The account features module 204 can then use the respective number of URL tokens that match page tokens (and/or profile tokens) as features. For example, in some embodiments, the number of tokens in the URL that match page tokens can be used as a feature for training the model. In some embodiments, the number of tokens in the URL that match profile tokens can be used as a feature for training the model. In some embodiments, the set of page tokens and/or the set of profile tokens may vary based on the geographic region. In such embodiments, the user's geographic location can be used to identify a corresponding set of page tokens and/or profile tokens and these sets of tokens can be used to determine various features, as described above.

In some embodiments, the account features module 204 determines one or more features based on a relationship status specified in the social profile. For example, the user may specify a relationship status (e.g., single, married, etc.) that is displayed in the social profile. Such relationship statuses are typically not specified in social profiles of businesses. In such embodiments, a feature used to train the model can reference a first value (e.g., 1) if a relationship status was specified or a second value (e.g., 0) if no relationship status was specified.

In some embodiments, the account features module 204 determines one or more features based on the types of social connections that are associated with the user. For example, the user's social connections may include family members, classmates, coworkers, and general acquaintances. In some embodiments, the account features module 204 can determine a count of the user's social connections that are classmates using, for example, the social graph that is maintained by the social networking system. In such embodiments, the number of social connections that are classmates of the user can be used as a feature for training the model. In some embodiments, the account features module 204 can determine a count of the user's social connections that are family members. In such embodiments, the number of social connections that are family members of the user can be used as a feature for training the model. In one example, the account features module 204 can determine the count using the social graph that is maintained by the social networking system. In another example, the account features module 204 can determine the count based on information specified in the social profile that describes family relationships.

The messaging features module 206 can be configured to determine a number of different features based on messages sent by the user through the social networking system. For example, in some embodiments, the messaging features module 206 can determine a count of birthday greetings sent by the user to social connections (or other users) through the social networking system. In such embodiments, the number of birthday greetings sent can be used as a feature for training the model. In some embodiments, the messaging features module 206 can determine a count of birthday greetings that were sent to the user from social connections (or other users) through the social networking system. In such embodiments, the number of birthday greetings sent to the user can be used as another feature for training the model.

In some embodiments, the messaging features module 206 can determine a count of message threads that are active between the user and one or more other users of the social networking system. In such embodiments, the number of active message threads is used as a feature for training the model. In general, the user may send messages to other users through the social networking system. A corresponding message thread is typically created when a message is sent or received and such threads can be used to continue the exchange of messages. In some embodiments, the messaging features module 206 can obtain information (e.g., likelihoods) identifying message threads that are expected to have a threshold amount of messaging activity. Such likelihoods can be used alone, or in the aggregate, as features for training the model. In some embodiments, the messaging features module 206 can determine a count of messages sent by the user to other users that included identical, or similar, content. In such embodiments, this count can be used as a feature for training the model.

The image features module 208 can be configured to determine a number of different features based on various media associated with the user's account. For example, in some embodiments, the image features module 208 can determine a count of content albums that were created by the user through the social networking system. In such embodiments, this count can be used as a feature for training the model. In general, a content album can be used to organize various content items that were posted by the user.

In some embodiments, the image features module 208 can determine a count of content items (e.g., images, videos, etc.) that were posted by the user through the social networking system. In such embodiments, this count can be used as a feature for training the model.

In some embodiments, the image features module 208 can determine a count of social connections (or other users) that were tagged by the user in posts (e.g., posted messages, posted content items, etc.). In such embodiments, this count can be used as a feature for training the model. For example, the user may tag one or more social connections in a content item to indicate that the content item may be of interest to the tagged social connections. In some instances, a user promoting a product or service as part of their business may tag many social connections. In such instances, the amount of tagging performed by the user can be used as a signal to differentiate between an individual user and a business user.

In some embodiments, the image features module 208 can determine a count of human faces that appear in a profile photo associated with the user's account. In such embodiments, this count can be used as a feature for training the model. In some embodiments, the image features module 208 can determine a ratio of a first portion of the profile photo that corresponds to a human face and a second portion of the profile photo that corresponds to the remaining subject matter in the profile photo. In such embodiments, this ratio can be used as a feature for training the model.

In some embodiments, the image features module 208 can determine a count of the user's uploaded images that include predetermined subject matter (e.g., human faces, overlaid text, etc.). In such embodiments, this count can be used as a feature for training the model. In general, the predetermined subject matter (e.g., identities, or names, of individuals, human faces and other features, objects, activities, products, logos, animals, points of interest, or other concepts) can correspond concepts that are useful in differentiating between social pages corresponding to individuals and social pages corresponding to organizations.

In various embodiments, the image features module 208 can analyze a content item (e.g., image) by applying a machine learning model (content classifier) to the image. In particular, the image features module 208 can determine a probability regarding whether the image reflects predetermined subject matter (e.g., identities, or names, of individuals, human faces and other features, objects, activities, products, logos, animals, points of interest, or other concepts). The content classifier can be based on any machine learning technique, including but not limited to a deep convolutional neural network. The content classifier supported by the image features module 208 can be trained and tested to determine the subject matter reflected in an image. In a development phase, contextual cues for a sample set of images can be gathered. Images classes corresponding to various subject matter can be determined. Correlation of the sample set of images with the image classes based on the contextual cues can be determined. A training set of images can be generated from the sample set of images based on scores indicative of high correlation. The training set of images can be used to train the content classifier to generate visual pattern templates of the image classes. In an evaluation phase, the content classifier can be applied to a new image to determine the subject matter reflected in the new image. In some embodiments, upon processing an input image, the content classifier outputs a set of image features that correspond to the subject matter reflected in the inputted image. For each feature, the content classifier can also output a respective probability indicating a likelihood that the feature was found in the subject matter reflected by the inputted image.

In some embodiments, any of the features described herein can reference a binary value rather than an actual count corresponding to the feature. In such embodiments, a feature can simply reference a first value (e.g., 1) if some threshold is satisfied or a second value (e.g., 0) if the threshold is not satisfied. For example, rather than using the actual number of content items that were posted by the user as a feature, the feature can instead reference a value of 1 if a threshold number of content items were posted by the user or a value of 0 if this threshold number is not satisfied.

FIG. 3 illustrates an example of a model training module 302, according to an embodiment of the present disclosure. In some embodiments, the model training module 108 of FIG. 1 can be implemented as the model training module 302. As shown in FIG. 3, the model training module 302 can include a training data module 304 and a training module 306.

In various embodiments, the training data module 304 is configured to generate training data to be used for training a machine learning model (or classifier) for identifying user accounts that should be transitioned from using social profiles to using social pages. The training data used to train the model can include a number of training examples. In some embodiments, the training data module 304 can train the model using a set of positive training examples. For example, one or more features extracted from social profiles that were converted to social pages (e.g., using the account conversion module 104) can be used as positive training examples. In some embodiments, the training data module 304 can train the model using a set of negative training examples. For example, one or more features extracted from random user social profiles can be used as negative training examples. The features included in a training example can be determined using any of the approaches described above.

The training module 306 can use these training examples to train the machine learning model. In general, any type of machine learning model may be used. In some embodiments, an ensemble learning method is used to train the model such as boosted decision trees, for example.

FIG. 4 illustrates an example evaluation module 402, according to an embodiment of the present disclosure. In some embodiments, the evaluation module 110 of FIG. 1 can be implemented as the evaluation module 402. As shown in FIG. 4, the evaluation module 402 can include a profile evaluation module 404 and a notification module 406.

In some embodiments, the profile evaluation module 404 can obtain information describing a social profile to be evaluated using the trained model. The profile evaluation module 404 can determine a set of features corresponding to the social profile using any of the approaches described above. This set of features will generally correspond to the set of features that were used to train the model. The set of features can be provided to the model as input. In response, the model can output information indicating whether the user account associated with the social profile should be transitioned to a social page rather than the social profile.

In some embodiments, the notification module 406 is configured to send one or more notifications that inform the user of the option to transition from using the social profile to a social page. The user can automatically convert their social profile to a social page using, for example, the account conversion module 104, as described above. In some embodiments, once the user opts to transition to the social page, information describing the user's social profile can be used as another training example for training the model.

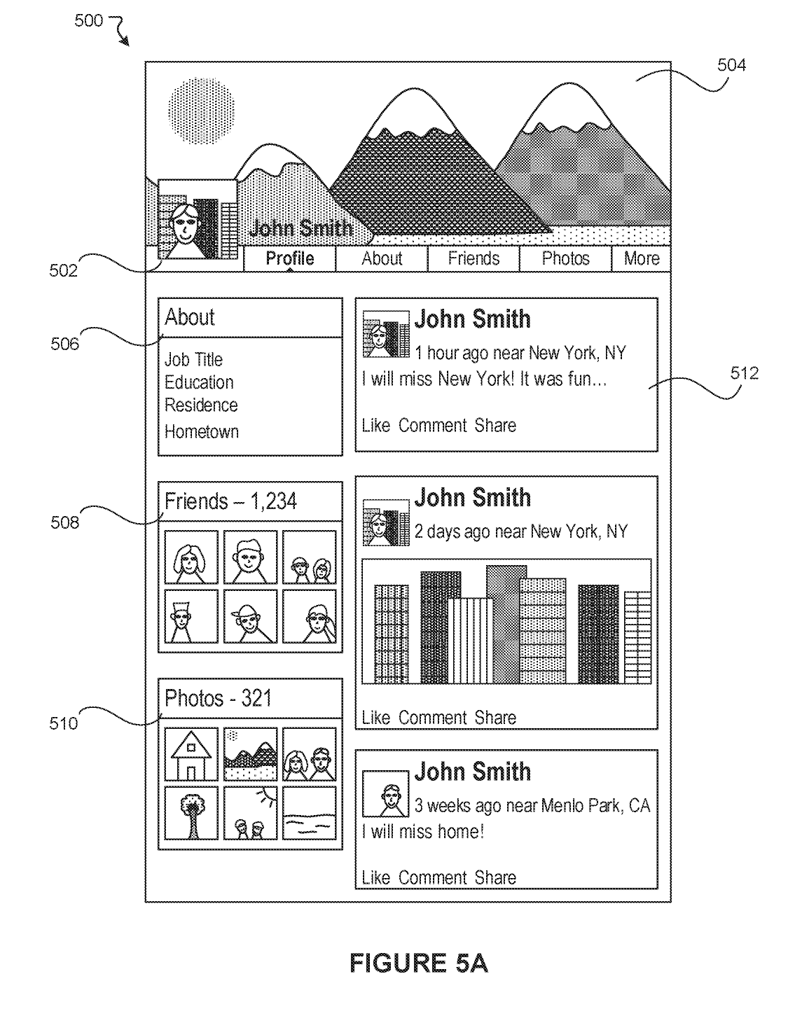

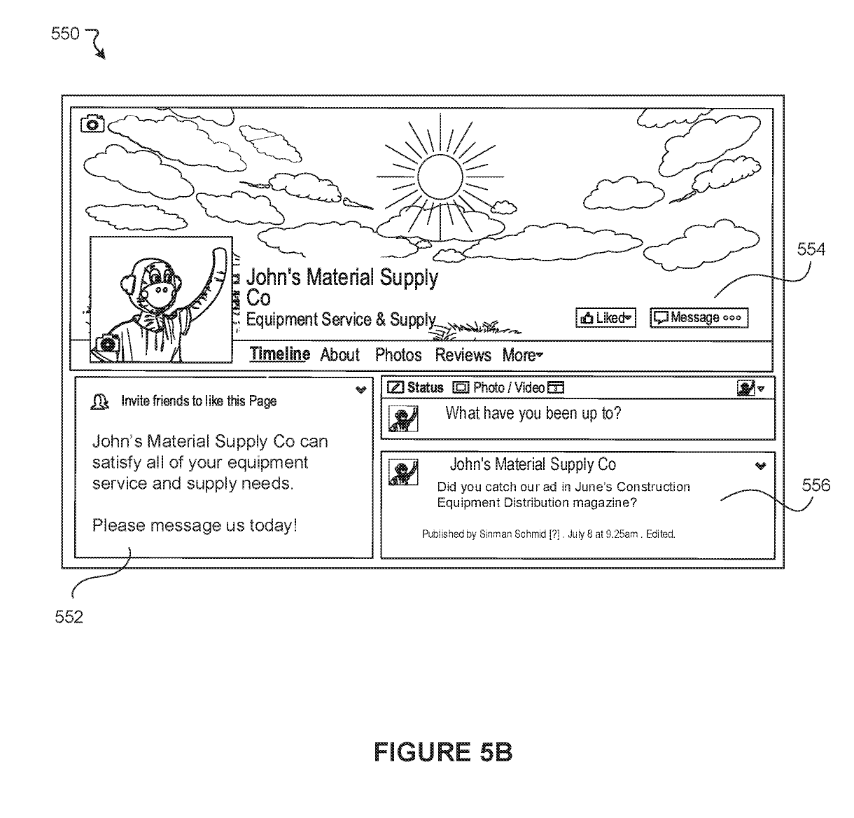

FIG. 5A illustrates an example social profile 500, according to various embodiments of the present disclosure. The social profile 500 belongs to a user John Smith of the social networking system (e.g., the social networking system 730 of FIG. 7). As shown in FIG. 5A, the user has selected a profile picture 502 and a cover photo 504 to be displayed in the social profile 500. The social profile includes various information 506 about the user, social connections 508 of the user, content items 510 posted by the user, and posts 512 published in the social profile 500. In contrast, FIG. 5B illustrates an example social page 550. The social page 550 includes various information 552 about the page including, for example, hours of operation, menus, lists of goods and/or services offered, photos, and reviews. The social page 550 also includes an option 554 for messaging an administrator of the social page 550 as well as posts 556 published in the social page 550. An administrator of the social page 550 can access various tools that help the administrator to develop the social page 550. In one example, the administrator can create advertisements to promote the social page 550 through the social networking system. In another example, the administrator can access information that describes how users of the social networking system have interacted with the social page 550.

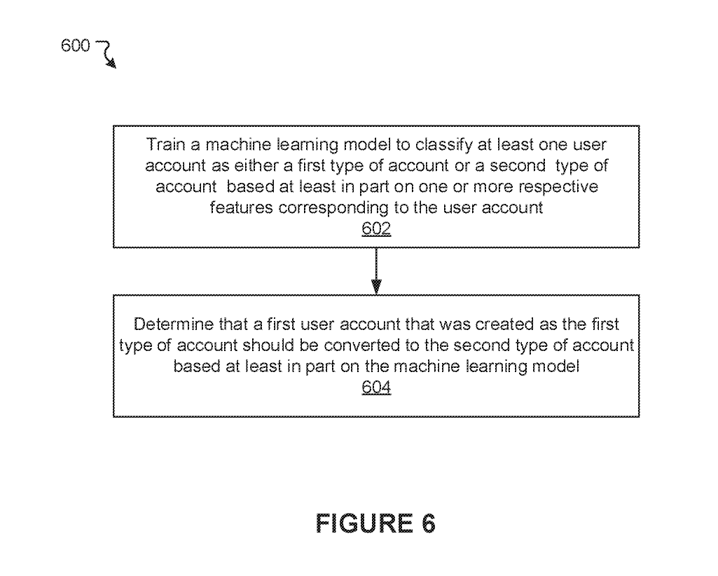

FIG. 6 illustrates an example process 600 for evaluating user accounts, according to various embodiments of the present disclosure. It should be appreciated that there can be additional, fewer, or alternative steps performed in similar or alternative orders, or in parallel, within the scope of the various embodiments discussed herein unless otherwise stated.

At block 602, a machine learning model is trained to classify at least one user account as either a first type of account or a second type of account based at least in part on one or more respective features corresponding to the user account. At block 604, a determination is made that a first user account that was created as the first type of account should be converted to the second type of account based at least in part on the machine learning model.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content. As discussed previously, it should be appreciated that there can be many variations or other possibilities.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include an account transition module 746. The account transition module 746 can, for example, be implemented as the account transition module 102 of FIG. 1. In some embodiments, the account transition module 746, in whole or in part, may be implemented in a user device 710 or the external system 720. As discussed previously, it should be appreciated that there can be many variations or other possibilities.

### Hardware Implementation

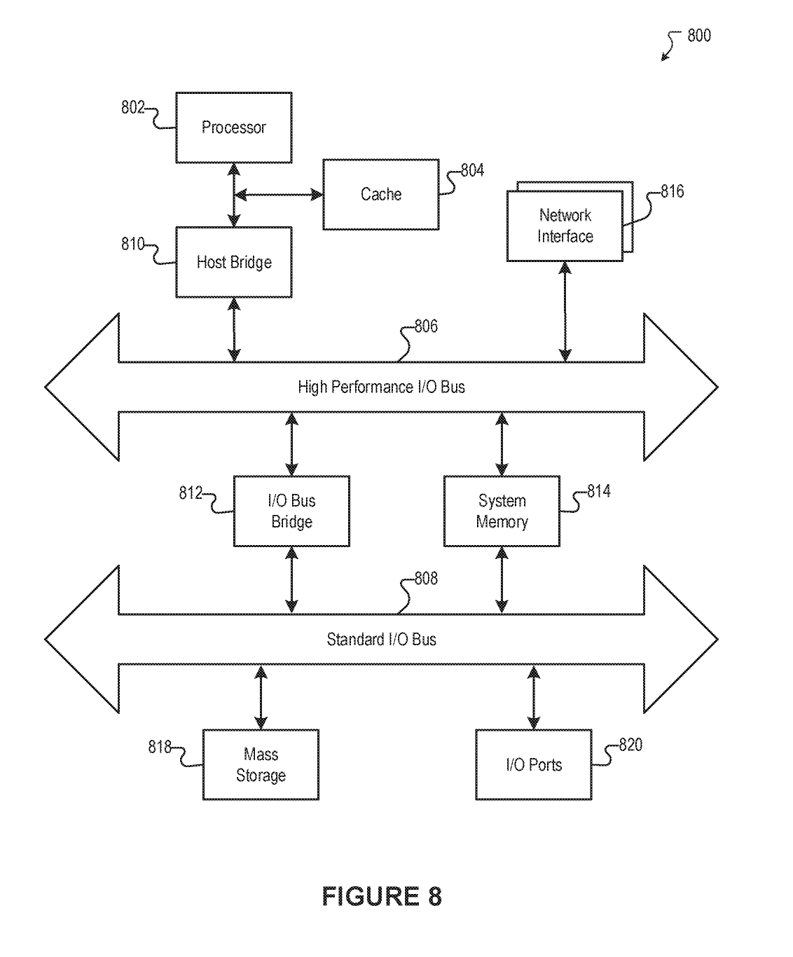

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
training, by a computing system, a machine learning model to classify at least one user account as either a first type of account or a second type of account based at least in part on one or more respective features corresponding to the user account; and
determining, by the computing system, that a first user account that was created as the first type of account should be converted to the second type of account based at least in part on the machine learning model.

2. The computer-implemented method of claim 1, wherein the first type of account corresponds to a social profile in a social networking system, and wherein the second type of account corresponds to a social page in the social networking system.

3. The computer-implemented method of claim 1, the method further comprising:
providing, by the computing system, at least one notification instructing a user associated with the first user account to convert the first user account to the second type of account.

4. The computer-implemented method of claim 1, wherein training the machine learning model further comprises:
generating, by the computing system, a set of training examples that each include a set of features that describe social profiles of a plurality of users.

5. The computer-implemented method of claim 4, wherein the set of features include a count of the user's social connections that are also social connections of one another in a social networking system.

6. The computer-implemented method of claim 4, wherein the set of features include a count of tokens determined from information associated with the user that match one or more predefined tokens, the predefined tokens referencing terms that are associated with the second type of account.

7. The computer-implemented method of claim 4, wherein the set of features include information indicating a relationship status of the user as specified in a social networking system.

8. The computer-implemented method of claim 4, wherein the set of features include a count of the user's social connections that are family members in a social networking system.

9. The computer-implemented method of claim 4, wherein the set of features include a count of birthday greetings sent by the user to social connections through a social networking system.

10. The computer-implemented method of claim 4, wherein the set of features include a count of message threads that are active between the user and one or more other users of a social networking system.

11. A system comprising:
at least one processor; and
a memory storing instructions that, when executed by the at least one processor, cause the system to perform:
training a machine learning model to classify at least one user account as either a first type of account or a second type of account based at least in part on one or more respective features corresponding to the user account; and
determining that a first user account that was created as the first type of account should be converted to the second type of account based at least in part on the machine learning model.

12. The system of claim 11, wherein the first type of account corresponds to a social profile in a social networking system, and wherein the second type of account corresponds to a social page in the social networking system.

13. The system of claim 11, wherein the instructions further cause the system to perform:
providing at least one notification instructing a user associated with the first user account to convert the first user account to the second type of account.

14. The system of claim 11, wherein training the machine learning model further causes the system to perform:
generating a set of training examples that each include a set of features that describe social profiles of a plurality of users.

15. The system of claim 14, wherein the set of features include a count of the user's social connections that are also social connections of one another in a social networking system.

16. A non-transitory computer-readable storage medium including instructions that, when executed by at least one processor of a computing system, cause the computing system to perform a method comprising:
training a machine learning model to classify at least one user account as either a first type of account or a second type of account based at least in part on one or more respective features corresponding to the user account; and
determining that a first user account that was created as the first type of account should be converted to the second type of account based at least in part on the machine learning model.

17. The non-transitory computer-readable storage medium of claim 16, wherein the first type of account corresponds to a social profile in a social networking system, and wherein the second type of account corresponds to a social page in the social networking system.

18. The non-transitory computer-readable storage medium of claim 16, wherein the instructions further cause the computing system to perform:
providing at least one notification instructing a user associated with the first user account to convert the first user account to the second type of account.

19. The non-transitory computer-readable storage medium of claim 16, wherein training the machine learning model further causes the computing system to perform:
generating a set of training examples that each include a set of features that describe social profiles of a plurality of users.

20. The non-transitory computer-readable storage medium of claim 19, wherein the set of features include a count of the user's social connections that are also social connections of one another in a social networking system.
